(19) United States
(12) Patent Application Publication
(10) Pub. No.: US 2004/0261206 A1
(43) Pub. Date: Dec. 30, 2004

(54) Cleaning slabs in front of the roller hearth furnace of a mini mill

(76) Inventors: Bernhard Ehls, Hilchenbach (DE); Kirsten Fieger-Schlangen, Grevenbroich (DE); Ingo Schuster, Willich (DE); Jurgen Armenat, Kreuztal (DE)

Correspondence Address: FRIEDRICH KUEFFNER, 317 MADISON AVENUE, SUITE 910, NEW YORK, NY, 10017, US

(21) Appl. No.: 10/489,004

(22) PCT Filed: Aug. 28, 2002
(86) PCT No.: PCT/EP02/09572

(30) Foreign Application Priority Data
Sep. 7, 2001 (DE) 101 43 868.0

(51) Int. Cl. B08B 3/02

(52) U.S. Cl. 15/77; 134/2; 134/32; 134/15

(57) ABSTRACT

The invention relates to a device for removing loose cinder from the surface of a slab, especially a thin slab of a mini mill. One such mini mill comprises at least one slab casting machine, a slab separating device, a thermal compensation furnace and at least one roll stand comprising a reeling installation. The inventive device is improved in that a spray device (11) comprises at least one lower spray pipe (2) and at least one upper spray pipe (3) in relation to the slab (1), each spray pipe being fitted with a number of spray nozzles (4). Said spray device (11) is arranged in front of the roller hearth furnace (5) of the mini mill and is connected to a water supply (6) having the technologically required pressure and a volume flow which is adapted to the number of spray nozzles (4). The invention also relates to an operating method for the spray device (11).

The invention concerns equipment for removing loose scale from the surface of a slab, especially a thin slab of a mini mill, which comprises at least a slab casting machine, a slab cutter, a soaking furnace, one or more rolling stands with a coiler, and a spray system for the loose scale, which has at least one spray pipe installed below the slab and at least one spray pipe installed above the slab, such that each spray pipe is equipped with a number of spray nozzles, is installed in front of the soaking furnace, especially a roller hearth furnace, and is connected to a water supply that has the technologically required pressure and a volume flow that is suitably rated for the number of spray nozzles. The invention also concerns a method of operating the specified equipment.

The slab produced by the casting machine is naturally covered with scale. As a rule, a scale-covered slab is conveyed to the roller hearth furnace of a mini mill without being cleaned. This can cause scale that has been carried into the roller hearth furnace with the slab to build up on the furnace rollers during the period of operation to form irregular accumulations of scale (pickup formation). This can cause impressions to be left on the underside of the slab, which adversely affects the surface quality of the slab and of the finished rolled strip. Furthermore, the loosely adherent scale acts as an insulating layer, which impairs heat transfer during the heating of the slab in the roller hearth furnace.

Methods and equipment for cleaning slabs of both loose scale and strongly adherent scale with high-pressure water spray jets are well known.

For example, the document JP 11[1999]-047,820 describes a method for removing strongly adherent scale from the surface of a slab by spraying large amounts of low-pressure water and then spraying small amounts of high-pressure water onto the surface of the slab to effect shock-like cooling of the surface to 300-400° C. with the low-pressure water and then to rinse off the detached scale by the mechanical action of the high-pressure water. The high-pressure water is sprayed onto the slab at a pressure of about 200-300 bars to clean the scale off by its mechanical action.

The document JP 10[1998]-128,425 describes equipment for descaling a heated slab at the discharge end of a heating furnace. Approximately 10 seconds after the slab leaves the furnace, preliminary descaling is first carried out with equipment that sprays low-pressure water at a pressure of about 20 bars onto the surface of the slab for 30 seconds to produce thermal stress. High-pressure water at about 120 bars is then sprayed onto the surface of the slab with water jets 30 seconds after the cooling by the low-pressure water to achieve complete descaling.

The document JP 2002-121,714 describes descaling equipment with devices for injecting high-pressure water spray jets with an effective pressure of about 10 kg/cm² onto the front and back sides of a steel strip emerging from a continuous casting plant.

The paper by “E. A. Donini et al.: Flexible Thin-Slab Rolling: Matching the Requirements of Integrated Producers. Iron and Steel Engineer, Association of Iron and Steel Engineers, Pittsburgh, U.S., Vol. 74, No. 6, Jun. 1, 1997 (Jun. 1, 1997), pages 39-44, XP000658413, ISSN: 0021-1559” describes a continuous casting plant with integrated descaling equipment, in which water jet nozzles with high-power nozzle jets sweep over the upper and lower sides of a rolled strip with circular movements and loosen the layer of scale.

The document EP 0 846 508 A discloses a continuous casting plant with a withdrawing device that follows a soft-reduction device, followed by a cutting device and a furnace for raising the temperature, and with descaling equipment that uses water, which is installed upstream of the cutting device, such that the heating furnace is installed in a position close to the discharge end of the cutting device.

The document JP 2001-091,908 A discloses a descaling device with water spray nozzles that act together with a rotating wire brush in front of a heating furnace.

The document DE 41 33 898 A describes a method for removing casting slag or casting scale on continuous casting starting material for the production of hot-rolled wide strip with improved surface properties with the use of thin-slab continuous casting and rolling technology. The casting slag or scale is removed by spraying the surface of the strand with pressurized water before the strand enters a heating furnace installed after the continuous casting installation, such that the secondary cooling of the installation is controlled in such a way that the entrance temperature of the thin slabs is held at the same level.

Proceeding from the prior art described above, the objective of the invention is to specify improved descaling technology and corresponding spray equipment, especially for mini mills, for the purpose of cleaning a slab with the least possible heat loss from the slab, reducing the amount of scale brought into the roller hearth furnace, and improving the surface quality of the hot-rolled strip.

To achieve this objective, the invention provides that, in equipment of the type specified in the introductory clause of Claim 1, the spray system is designed in such a way that removed scale and used water are delivered to a scale pit with a water/solids separator installed in its outlet.

The specified features of the invention make it possible to clean a slab with the least possible heat loss, to reduce the amount of scale brought into the roller hearth furnace, and to prevent the formation of pickup on the furnace rollers of the roller hearth furnace. Moreover, heat transfer into the slab in the roller hearth furnace is improved, and, all together, there is an increase in the surface quality of the hot-rolled strip.

Further refinements of the equipment of the invention are specified in the dependent claims.

A method for spraying loose scale from the surfaces of a slab is advantageously characterized by the fact that the delivery pressure of the water to the spray pipes of the spray system is 5-15 bars, and preferably <10 bars. The method advantageously works by the principle of thermal shock.

The spray method of the invention is especially advantageous if it is carried out before the slabs are delivered into the roller hearth furnace.

Further advantageous refinements of the method of operation are specified in the additional dependent claims.

The invention is explained in greater detail below with reference to the drawing.

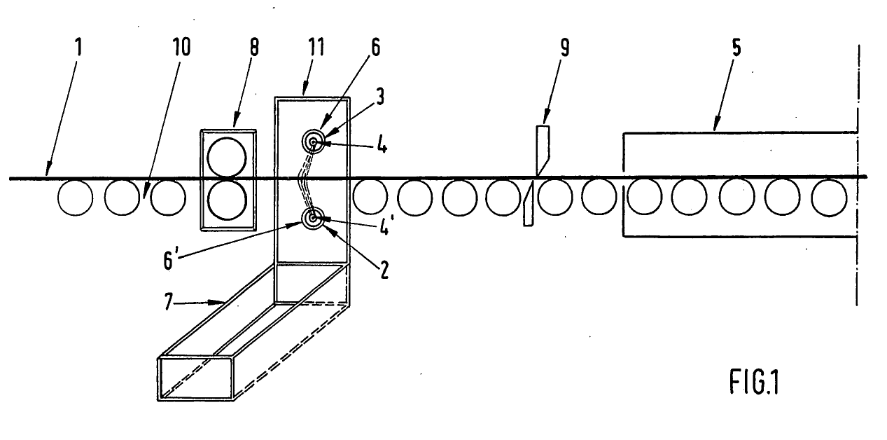

FIG. 1 shows a flow chart of the equipment of the invention.

As shown in the schematic drawing, a slab 1, which is cast as a thin slab in a casting machine (not shown), is first conveyed on a roller table 10 to a straightening driver 8, which conveys the thin slab 1 to a spray system 11 for the spraying of the surface of the slab. This spray system 11 represents the actual invention and comprises at least one lower spray pipe 2 and at least one upper spray pipe 3. The spray pipes 2, 3 are installed in stationary positions, and each of the spray pipes is equipped with a number of spray nozzles 4, which are directed towards the surface of the slab 1. Each spray pipe 2, 3 is connected to a water supply 6 that has the technologically required pressure and a volume flow that is suitably rated for the number of spray nozzles 11. The spray system 11 is installed in front of the roller hearth furnace 5 but behind the straightening driver 8. A slab cutter 9, which is designed as a shear, is located between the spray system 11 and the roller hearth furnace 5 and cuts the slab to commercial weights. The scale removed from the scale-covered surface by spraying in the spray system and the used water are delivered to a scale pit 7 with a water/solids separator installed in its outlet. The operating parameters of the spray system are adjusted in such a way that the delivery pressure of the water to the spray pipes 2, 3 is 5-15 bars, and preferably <10 bars. The scale loosely attached to the surface of the slab is loosened and removed from the surface by the principle of thermal shock. As mentioned above, the detached scale and the spray water are delivered to the scale pit 7, where they are separated into their constituent parts.

The spray system 11 is not necessarily installed between the straightening driver 8 and the roller hearth furnace 5, as shown in FIG. 1, but rather it is possible, without conflict with the idea of the invention, to install the spray system 11 between the shear 9 and the roller hearth furnace 5 in the direction of passage of the slab. In a slab installation that possibly also has a roughing stand for reducing the thickness of the slab, the spray system 11 may be installed between the roughing stand and the roller hearth furnace 5. In any case, even if a different plant layout is used, the spray system 11 should be installed in front of the roller hearth furnace.

With the spray system of the invention, which, in contrast to the prior art, is not a descaling spray system for removing strongly adherent furnace scale, the slab cleaning can be carried out with low heat losses of the slab. In addition, the amount of scale brought into the roller hearth furnace and thus the scale pickup on the furnace rollers are reduced. The reduced amount of scale on the surfaces of the slab improves heat transfer into the slab in the roller hearth furnace and makes it possible to improve the surface quality of the hot-rolled strip produced in the subsequent rolling stands.

1. Equipment for removing loose scale from the surface of a slab, especially a thin slab of a mini mill, which comprises at least a slab casting machine, a slab cutter, a soaking furnace, one or more rolling stands with a coiler, and a spray system (11) for the loose scale, which has at least one spray pipe (2) installed below the slab (1) and at least one spray pipe (3) installed above the slab (1), such that each spray pipe (2, 3) is equipped with a number of spray nozzles (4), is installed in front of the soaking furnace (5), especially a roller hearth furnace, and is connected to a water supply (6) that has the technologically required pressure and a volume flow that is suitably rated for the number of spray nozzles (4), wherein the spray system (11) is designed in such a way that removed scale and used water are delivered to a scale pit (7) with a water/solids separator installed in its outlet.

2. Equipment in accordance with claim 1, wherein the spray system (11) is installed between a straightening driver (8) and the roller hearth furnace (5) in the direction of passage of the slab.

3. Equipment in accordance with claim 2, wherein the slab cutter (9), especially a shear, is installed between the spray system (11) and the roller hearth furnace (5).

4. Equipment in accordance with claim 1, wherein the spray system (11) is installed between the slab cutter (9) and the roller hearth furnace (5) in the direction of passage of the slab.

5. Method of operation of the equipment for removing loose scale from the surface of a slab, especially a thin slab of a mini mill, by means of a spray system (11) in accordance with claim 1, wherein the delivery pressure of the water to the spray pipes (2, 3) of the spray system (11) is 5-15 bars, and preferably <10 bars.

6. Method in accordance with claim 5, wherein the loosely adherent scale on the surface of the slab is removed by the principle of thermal shock.

7. Method in accordance with claim 5, wherein the descaling is carried out with the least possible heat loss of the slab (1).

8. Method in accordance with claim 5, wherein the spraying method is carried out before the slab (1) is directed into the roller hearth furnace (5).
